(19) United States
(12) Patent Application Publication
(10) Pub. No.: US 2006/0013397 A1
(43) Pub. Date: Jan. 19, 2006

(54) Channel adapter managed trusted queue pairs

(75) Inventors: Rainer Dorsch, Herrenberg (DE); Martin Eckert, Jettingen (DE); Markus Helms, Boeblingen (DE); Walter Lipponer, Ammerbuch (DE); Thomas Schlipf, Holzgerlingen (DE); Daniel Sentler, Magstadt (DE); Harmut Ulland, Altdorf (DE)

Correspondence Address: John E. Campbell;IBM Corporation, 2455 South Raod, P386, Poughkeepsie, NY, 12601, US

(73) Assignee: International Business Machines Corporation, Armonk, NY (US)

(21) Appl. No.: 11/178,761

(22) Filed: Jul. 11, 2005

(30) Foreign Application Priority Data
Jul. 13, 2004 (EP) 04103347.3

(51) Int. Cl. H04K 1/00

(52) U.S. Cl. 380/256

(57) ABSTRACT

An InfiniBand™ Channel Adapter encrypts or decrypts user data on-the-fly. The user data is read from system memory and encrypted in by the Channel Adapter before sending it to a network. Similarly received data is decrypted on the fly before storing it in system memory. The encryption/decryption keys are preferably stored in a Queue Pair Context storage area of system memory as Public key for sending data and Private key for receiving data.

### TECHNICAL FIELD

The present invention generally relates to digital network communication, and in particular to a method and system for processing data according to the InfiniBand™ (IB) Protocol with reduced latency and chip costs in an InfiniBand™ type computer system.

### BACKGROUND OF THE INVENTION

In the field of enterprise computer networks, e.g. as sketched in FIG. 1 by an enterprise's intranet 10, today's computer industry is moving toward fast, packetized, serial input/output (I/O) bus architectures, in which computing hosts like the exemplary database server 12 and peripherals like an Internet mail server 14 are linked by a switching network, commonly referred to as a switching fabric. A number of architectures of this type have been proposed, culminating in the “InfiniBand.™.” (IB) architecture, which has been advanced by a consortium led by a group of industry leaders. The IB architecture is described in detail in the InfiniBand™ Architecture Specification, which is available from the InfiniBand™-Trade Association at www.infinibandta.org and is incorporated herein by reference.

InfiniBand™ technology connects the hardware of two channel adapters 16, further abbreviated herein as CA, by using Queue Pairs further abbreviated herein as QPs. Those QPs have associated with them a Send Queue and a Receive Queue. The QPs are set up by software. So each application can have multiple QPs for different purposes. Each QP has associated with it a Queue Pair Context further abbreviated herein as QPC, which contains information about the type of the QP, e.g. whether it concerns a reliable or an unreliable connection.

If an application wants to use a QP, it has to send a Work Request, further abbreviated herein as WR, to the Channel Adapter (CA). A WR gets then translated into an InfiniBand-defined Work Queue Element, further abbreviated herein as WQE, and is made available on the send or receive queue of the QP. The list of WQEs, which belong to a given QP, is stored in the QPC. This is true not only for the sender, but for the receiver as well, except in cases of Remote Direct memory Access (RDMA). The WQEs contain information, where to store received data, in the system memory of the receiver computer.

With a special focus to the present invention the communicated data is very often confidential in nature, e.g., in banking applications, when personalized datasets are communicated within the Intranet of a bank enterprise. Thus, the data is sent in an encrypted form in prior art. In prior art the handling is as follows:

The confidential user data, i.e. the payload data, is residing in main memory 18. A plurality of key pairs is also stored in the system main memory 18.

The processor 10 reads the user data and the public key of the target node from memory, encrypts the data, writes the encrypted data back into main memory, and finally orders the CA, to transfer the respective encrypted main memory area to a given destination computer system via the Intranet according to the IB protocol. At the destination computer the data is stored in a pre-specified main memory area. The destination computer processor decrypts the data after fetching the private key from its storage location in main memory 18 and writes the decrypted data back into the main memory, where it is available of the actually desired further processing. This procedure is illustrated in FIG. 2, where the data handling is comparable both, at the sender 14, as well as at the receiver 12.

This general prior art handling of encrypting and decrypting data, when sent according the IB protocol, however, is disadvantageously quite complicated and occupies too many resources, as the prior art procedure includes multiple storing of data in main memory-encoded and decoded data, each storing as well as encryption and decryption being associated with the system's processor 10 activity. This increases disadvantageously latency.

U.S. Pat. No. 5,081,678 mentions the possibility that the network adaptor itself performs the task of encrypting and decrypting, respectively. The disadvantage is appreciated that in particular in larger networks where a large number of communication partner exist, a key table is required within the adopter's own memory, which is intolerably large and thus expensive, as the adaptor on-board memory is quite expensive compared to usual DRAM system memory. This prior art patent discloses to use a master key agreed on in advance between a plurality of communication partners, and to include a session key into the first data packet of an intended communication. Only by aid of the master key it is possible to decrypt the session key. This session key is then used for decrypting the rest of the communication.

Although the key table memory may be saved and thus memory chip costs can be saved in relation to the above U.S. patent's prior art, the U.S. patent's disclosure disadvantageously bears the risk that, if the master key is known to any undesired third person, not only the communication between a single pair of communicating partners, but the communications of multiple partners subsumed under the same master key can be decrypted. This is a risk, which might be considered as extremely high.

### SUMMARY OF THE INVENTION

It is thus an objective of the present invention to alleviate the before-mentioned disadvantages, in order to find a compromise between the described disadvantages of high risks and high memory chip costs.

This objective of the invention is achieved by the features stated in enclosed independent claims. Further advantageous arrangements and embodiments of the invention are set forth in the respective subclaims. Reference should now be made to the appended claims.

The idea behind the present invention is to do the encryption process within the adaptor itself and to store the encryption key, or the key pair of public and private key in main memory instead of in the adaptor's memory chip. In case of InfiniBand™ (IB) technology the key pair is stored within the Queue Pair Context common for a Queue Pair, i.e. in an adaptor's cache memory, if present, but in any case in the system memory. In case of RSA encryption the respective public encryption key of the send queue, as well as the private key of the receive queue is stored within the common Queue Pair Context (QPC) of a respective such Queue Pair, as the QPC is the actual logical storage unit relevant for control data of a 1:1 queue pair connection. The present invention is thus applicable generally to queue-based and context-based communication protocols.

The main advantage is that latency is reduced during encryption or decryption, as a multiple rewriting of user data into the system main memory—in an encoded as well as a decoded form as done in prior art—is avoided. This saves memory space, and processor resources at the system, as it balances the processor load by giving some processing load to the Channel Adaptor.

Further advantageously, the steps of encrypting and sending user data as well as the steps of decrypting and storing user data are performed sequentially repeated for subsequent data sections, i.e. “on-the-fly”, without storing a complete encrypted or decrypted, respectively, copy of the data locally on the CA.

Thus, overall latency introduced by the encryption and decryption methods, is decreased and data can be exchanged faster.

An additional bonus effect can be obtained when InfiniBand™ technology is applied: Typically, the Queue Pair Context of a queue pair is stored in system memory. Thus, for the purpose of cryptographic handling, once a 1:1 relationship exists between the sender and the receiver, which is reflected by such queue pairs, the respective Queue Pair Context may be easily enriched by the encryption key or the decryption key, if required.

According to this basic aspect the user data are not stored in main memory in an encrypted form, but instead in decrypted form only. The encrypted data is temporary resident only in the CA, preferably as long as required until the completion of the communication and optionally the successful decryption is acknowledged by the receiver.

Further, the user has an easier handling, as he need not manage both, the clear form and the encrypted form of his data. By storing the keys in the Queue pair Context in system memory the system has the full control over any keys applied in the procedure, but has not the processing load associated with it.

Further, costs of the CA is reduced as the CA memory and CA cache size may be reduced in size, as the keys are stored in system memory at the storage location storing all Queue Pair Contexts. Further, the keys can be easily integrated into the QPC, as only a minor change needs to be done in the IB protocol, in order to reserve some fields for controlling the status and the type of the encryption and for the encryption/decryption keys themselves, or for respective handle giving a reference for a key or a key pair.

### BRIEF DESCRIPTION OF THE DRAWINGS

The present invention is illustrated by way of example and is not limited by the shape of the figures of the drawings in which:

FIG. 1 is a schematic prior art representation illustrating a system overview for applying InfiniBand™ technology;

FIG. 2 is a more detailed view on the main hardware and software components for a communication partner, both applicable at sender and receiver;

FIG. 3 is a schematic representation according to FIG. 2 and illustrating the inventional structural and logical elements;

FIG. 4 is a schematic representation showing the additional fields to be provided in the Queue Pair Context according to a specific embodiment of the present invention;

FIG. 5 shows a control flow block diagram with the most relevant steps forming part of the inventional procedure in a preferred embodiment in an encryption procedure; and

FIG. 6 shows a control flow block diagram with the most relevant steps forming part of the inventional procedure in a preferred embodiment in a decryption procedure.

### BEST MODE FOR CARRYING OUT THE INVENTION

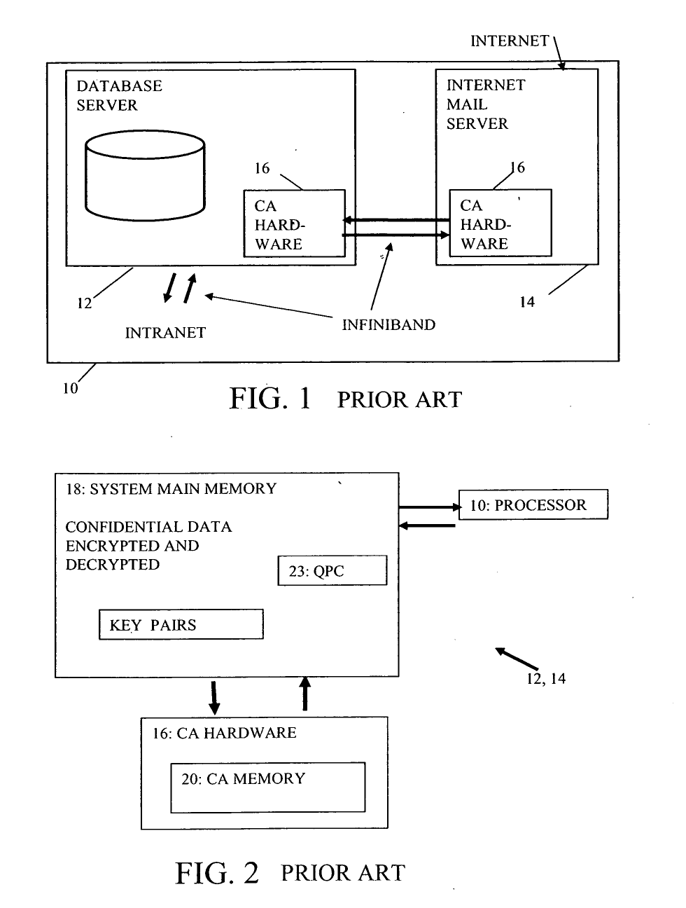

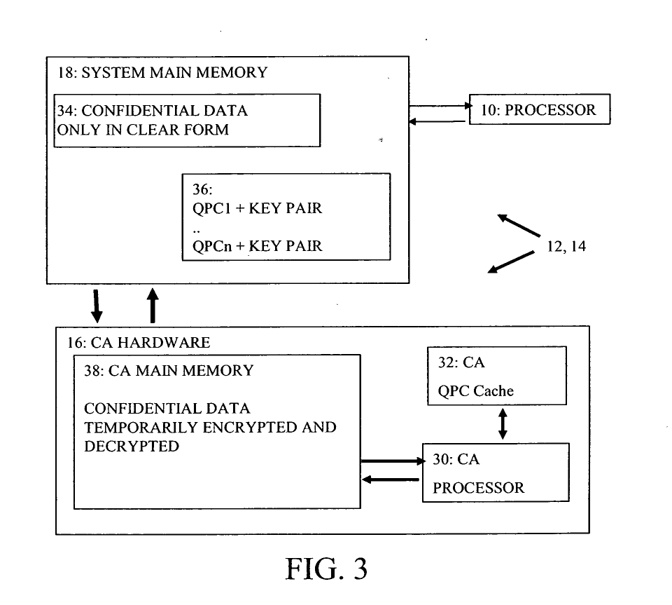

With general reference to the figures and with special reference now to FIG. 3 the system memory 18 of an exemplarily depicted database server 12 acting e.g. as a sender, see FIG. 1, comprises only user data 34 in clear form, i.e. in a form, which is not encrypted.

Further, in a predetermined QPC memory section 36 of the system memory 18 each of the stored queue pair contexts (QPC1 . . . QPCn) stores a respective public key and private key associated with the respective receiver, and sender, respectively. Processor 10 is not processing encryption or decryption tasks.

The channel adaptor 16 has own computational resources, as for example a main memory 38, a processor 30 and a cache 32 for caching the most relevant queue pair contexts. In the channel adapter's 16 main memory 38 the confidential user data is stored both in encoded and decoded form. The encryption and decryption is done by computational resources of the channel adapter 16.

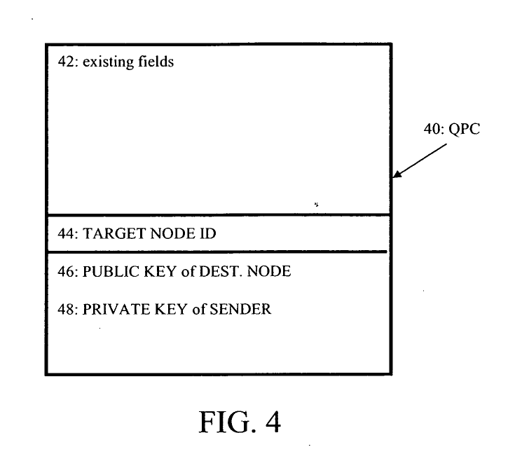

As FIG. 4 illustrates, a Queue Pair Context 40 maintained within the system memory 18 comprises existing fields 42 according to the requirements of the existing InfiniBand™ protocol as e.g. the target node ID 44 and others, but in particular according to the invention it contains the public key 46 of the target node and the private key 48 of the sender node.

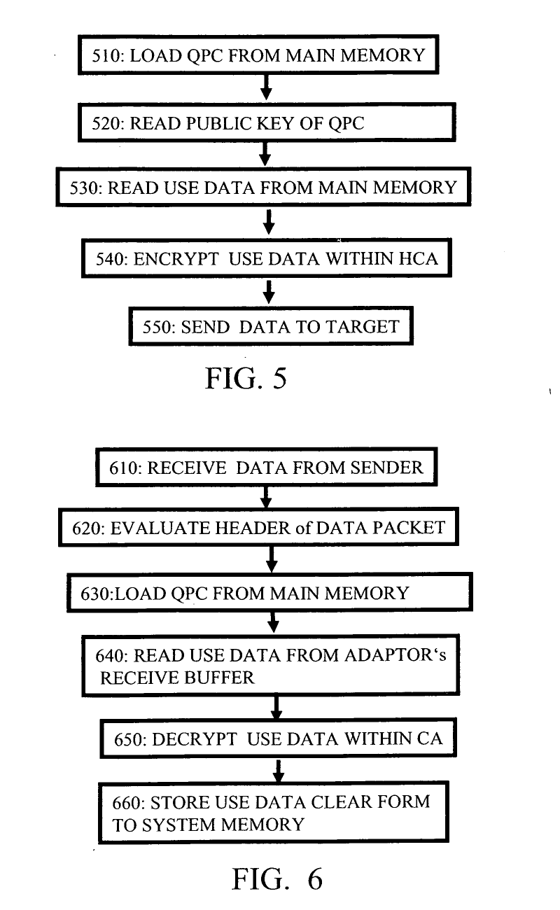

With particular reference to FIGS. 5 and 6 the inventional communication including the Channel Adapter residing encryption and decryption will be described.

First, in a step 510, at the sender computer system the channel adapter 16 loads the particular QPC of a predetermined Queue pair from main memory 18. Then the public key of the particular QPC is extracted from the context, step 520. This is also done by channel adapter's resources. Then, in an optional step 530 for situations, in which the WQE of the work request does not already contain the user data, the channel adapter reads the user data (payload) from the system memory, step 530, and encrypts the user data, step 540, with the public key of the receiver, just read. Then encrypted data is sent via the Intranet to the receiver computer, and in particular to the channel adapter thereof.

The next steps are performed by the channel adapter of the receiver computer system:

First, step 610, the data packets are serially received into a receive buffer.

In a step 620, the header of the first incoming packet is evaluated and the QPC associated with the current Queue Pair is identified. Then step 630, the respective QPC is loaded from receiver's main memory 18, or cache respectively, by which the decryption key is available in the channel adapter's memory.

Further, the encrypted user data freshly received is read from the receive buffer, step 640, and is decrypted, step 650, by the channel adapter's own computational resources, i.e. its processor 30.

Then the decrypted user data is transferred to the system main memory of the receiver system, step 660, where it is further processed by the user. The encrypted data is deleted from the cache and/cannel adapter main memory, when the transfer has completed and the decryption has completed successfully. Of course, the encrypted data can be stored elsewhere and for a longer time, if necessary.

It should be noted that advantageously, the steps 540 and 550, as well as steps 650 and 660, respectively, are performed “on-the-fly” without storing a complete encrypted or decrypted, respectively, copy of the data locally on the CA.

The present invention can be realized in hardware, software, or a combination of hardware and software. It can be implemented in channel adapters, like routers, bridges, etc. A tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following:
a) conversion to another language, code or notation;
b) reproduction in a different material form.

What is claimed is:

1. A method in a Channel adapter for encrypting user data of a packet being sent to a communication network, the method comprising the steps of:
the Channel adapter obtaining an encryption key from a system memory;
the Channel adapter obtaining user data from the system memory;
the Channel adapter encrypting the obtained user data using the obtained encryption key; and
the Channel adapter sending the Channel adapter encrypted obtained user data to the communication network.

2. The method according to claim 1 wherein the sending step comprises sending a first portion of encrypted obtained user data while a second portion of the obtained user data has not yet been encrypted for sending, the first portion of encrypted obtained user data comprising an encrypted first portion of obtained user data.

3. The method according to claim 1 wherein the encryption key comprises a pair of keys, the pair of keys comprising a public encryption key of a respective send queue and a private encryption key of a respective receive queue.

4. The method according to claim 1 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the obtaining an encryption key step comprises obtaining the encryption key from the Queue Pair Context in system memory.

5. The method according to claim 1 comprising the further steps of:
the Channel adapter obtaining an decryption key from a system memory;
the Channel adapter receiving encrypted user data from the communication network;
the Channel adapter decrypting the received user data using the obtained decryption key; and
the Channel adapter saving the decrypted received user data in system memory.

6. The method according to claim 1 wherein the saving step comprises saving a first portion of decrypted received user data while a second portion of the received user data has not yet been received, the first portion of decrypted user data comprising a decrypted first portion of received user data.

7. The method according to claim 1 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the decryption key is obtained from the Queue Pair Context in system memory.

8. A system for encrypting user data of a packet being sent to a communication network, the system comprising:
a network;
a Channel adapter in communication with the network wherein the Channel adapter includes instructions to execute a method comprising the steps of:
the Channel adapter obtaining an encryption key from a system memory;
the Channel adapter obtaining user data from the system memory;
the Channel adapter encrypting the obtained user data using the obtained encryption key; and
the Channel adapter sending the Channel adapter encrypted obtained user data to the communication network.

9. The system according to claim 8 wherein the sending step comprises sending a first portion of encrypted obtained user data while a second portion of the obtained user data has not yet been encrypted for sending, the first portion of encrypted obtained user data comprising an encrypted first portion of obtained user data.

10. The system according to claim 8 wherein the encryption key comprises a pair of keys, the pair of keys comprising a public encryption key of a respective send queue and a private encryption key of a respective receive queue.

11. The system according to claim 8 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the obtaining an encryption key step comprises obtaining the encryption key from the Queue Pair Context in system memory.

12. The system according to claim 8 comprising the further steps of:
the Channel adapter obtaining an decryption key from a system memory;
the Channel adapter receiving encrypted user data from the communication network;
the Channel adapter decrypting the received user data using the obtained decryption key; and
the Channel adapter saving the decrypted received user data in system memory.

13. The system according to claim 8 wherein the saving step comprises saving a first portion of decrypted received user data while a second portion of the received user data has not yet been received, the first portion of decrypted user data comprising a decrypted first portion of received user data.

14. The system according to claim 8 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the decryption key is obtained from the Queue Pair Context in system memory.

15. A computer program product for encrypting user data of a packet being sent to a communication network from a Channel adapter, the computer program product comprising:
a storage medium readable by a processing circuit and storing instructions for execution by a processing circuit for performing a method comprising the steps of:
the Channel adapter obtaining an encryption key from a system memory;
the Channel adapter obtaining user data from the system memory;
the Channel adapter encrypting the obtained user data using the obtained encryption key; and
the Channel adapter sending the Channel adapter encrypted obtained user data to the communication network.

16. The computer program product according to claim 15 wherein the sending step comprises sending a first portion of encrypted obtained user data while a second portion of the obtained user data has not yet been encrypted for sending, the first portion of encrypted obtained user data comprising an encrypted first portion of obtained user data.

17. The computer program product according to claim 15 wherein the encryption key comprises a pair of keys, the pair of keys comprising a public encryption key of a respective send queue and a private encryption key of a respective receive queue.

18. The computer program product according to claim 15 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the obtaining an encryption key step comprises obtaining the encryption key from the Queue Pair Context in system memory.

19. The computer program product according to claim 15 comprising the further steps of:
the Channel adapter obtaining an decryption key from a system memory;
the Channel adapter receiving encrypted user data from the communication network;
the Channel adapter decrypting the received user data using the obtained decryption key; and
the Channel adapter saving the decrypted received user data in system memory.

20. The computer program product according to claim 15 wherein the saving step comprises saving a first portion of decrypted received user data while a second portion of the received user data has not yet been received, the first portion of decrypted user data comprising a decrypted first portion of received user data.

21. The computer program product according to claim 1 wherein the Channel adapter comprises InfiniBand™ protocol comprising work Queue Pairs, each work Queue Pair comprising a send queue and a receive queue, each work Queue Pair having an associated Queue Pair Context, the work Queue pairs, and associated Queue Pair Context stored in system memory, wherein the decryption key is obtained from the Queue Pair Context in system memory.
